(19) United States
(12) Patent Application Publication
(10) Pub. No.: US 2017/0039650 A1
(43) Pub. Date: Feb. 9, 2017

(54) Method and system for the discovery, visualization, communication, alerting, capture and subsequent reporting of user actions and market information relating to the trading requirements and activities of investment management firms

(71) Applicant: Algomi Limited, London (GB)

(72) Inventors: Usman Khan, London (GB); Paul Stuart Taylor, London (GB)

(21) Appl. No.: 15/303,988

(22) PCT Filed: Apr. 14, 2015
(86) PCT No.: PCT/IB15/00486

§ 371 Date: Oct. 13, 2016

(30) Foreign Application Priority Data
Apr. 14, 2014 (GB) 1406665.8

(51) Int. Cl. G06Q 40/04; G06Q 40/02

(52) U.S. Cl. CPC G06Q 40/04; G06Q 40/02

(57) ABSTRACT

A system for conducting over the counter trades, the system comprising a first initiating party's computer system; a second responding party's computer system; and a Central Communication Hub in contact with the first and second parties' computer systems. The first system enables a user to input a trading interest in a financial instrument, and send information indicative of the trading interest to the Central Communication Hub. The Central Communication Hub makes a hidden request for information to the second system indicative of the second party's ability to fulfil the trading interest. The second system responds to the hidden request for information with summary information indicative of the second party's ability to fulfil the trading interest. The Central Communication Hub forwards some or all of the summary information response to the first party's system.

### BACKGROUND TO THE INVENTION

The invention relates to the use of information and trading systems by traders and sales people (collectively, “Users”) within regulated investment firms on the ‘buyside’ (“Investors”); such information being initially shared by ‘sellside’ banks and brokers (“Dealers”). The method and system described in this application provides discovery, visualization, collaboration (between Dealers and Investors), alerting, capture and subsequent reporting of User actions and market information relating to the trading requirements and activities of Investors in over the counter market environments.

### BACKGROUND TO THE INVENTION

In markets where there is no central counterparty (e.g. an exchange), trading takes place between two counterparties directly. This is known as over the counter trading (“OTC”). In such OTC markets, information tends to be far more fragmented and typically kept within the infrastructure of Dealers for the protective benefit of their own franchise.

From the perspective of an Investor, selection of specific Dealers as trading partners is of critical importance in order to minimize information leakage and ensure ‘best execution’ is achieved (being able to deliver best execution is fundamental to market integrity and to the delivery of good outcomes for clients who, in the context of both Investors and Dealers, rely their respective agents to act in their best interests). If this process is conducted badly (be it in an inefficient, disorganized or careless manner), a selected Dealer seeking to execute a trade for a client may inform the wider market without successfully executing the original trade. This is known as spoiling the market; if the Investor subsequently approaches a different Dealer, the information leakage may have influenced potential trade pricing to the detriment of the Investor.

In the fixed income market, a significant portion of bonds, typically 70% or more, are traded infrequently (less than daily). Accordingly, the market appetite and/or interest in such products is often uncertain or even unknown. An Investor looking to trade in such products will therefore have to rely upon their User's (the Investor's User who will execute the trade, the “Execution User”)) knowledge of the market and its participants' portfolio holdings to initiate such trades and to obtain best execution. Typically this process is largely carried out using the telephone and email by contacting a number of Dealers, and relies on the trust between the Investors and Dealers to ensure the best price and to prevent spoiling.

In the United Kingdom, in order to comply with regulatory obligations, information regarding the relevant Investor and Dealer parties, and the trade (including the steps leading to it) must be carefully recorded. Regulatory requirements require the “best execution” of the trade. This entails that the Execution User must obtain the best possible price for its client for the desired product. In Europe, there has been an attempt to define “best execution” within the Markets in Financial Instruments Directive (MiFID), requiring that the trader: “must take all reasonable steps to obtain the best possible result, taking into account price, costs, speed, likelihood of execution and settlement, size, nature or any other consideration relevant to the execution of the order.”

In the USA, the Securities and Exchange Commission requires that Investors are legally required to seek the best execution reasonably available for their customers' orders. To comply with this requirement, Investors evaluate the orders they receive from all customers in the aggregate and periodically assess which competing markets, market makers, or electronic communications networks (ECNs) offer the most favorable terms of execution.

Demonstrating the compliance with the regulatory requirements requires time and effort on behalf of the Investor.

In order to mitigate at least some of the market issues outlined above, the invention provides a method and apparatus of conducting efficient information sharing for OTC trades, between a first initiating party (the Investor), a second responding party (the Dealer) and a trusted third party (the service provider). The method comprising: the first party inputting a trading interest in a financial instrument, and sending information indicative of the trading interest to the service provider's central communication hub (“Central Communication Hub”); the Central Communication Hub, in response to the receipt of the information indicative of the trading interest, making a hidden request for information to the second system, the hidden request for information indicative of the second party's ability to fulfil the trading interest; the second system is responding to Central Communication Hub to the hidden request for information with summary information indicative of the second system indicative of the second party's ability to fulfil the trading interest; and the Central Communication Hub forwarding some or all of the summary information response to the first party's system.

Other aspects of the invention will be apparent from the appended claim set.

### BRIEF DESCRIPTION OF DRAWINGS

Embodiments of the invention are now described, by way of example only, with reference to the accompanying drawings in which:

FIG. 1 is a schematic of the apparatus according to an aspect of the invention;

FIG. 2 is a flow chart of the process of conducting over the counter trades according to an aspect of the invention;

FIG. 3 is a screen shot of an example of an inputted trading interest;

FIG. 4 is a screen shot of an example of the visualization of the dealer landscape generated in response to the trading interest;

FIG. 5 is a screen shot of a further example of the visualization of the dealer landscape generated in response to the trading interest;

FIG. 6 is a screen shot of a chat transcript generated between two parties;

FIG. 7 is a screen shot of an agreed trade.

FIG. 8 is a screen shot of an automatically generated audit log.

### DESCRIPTION OF AN EMBODIMENT OF THE INVENTION

The invention provides a system and methodology for conducting and executing OTC trades, which enables both Investors and Dealers to fully understand the market which is available to them. Furthermore, the present invention provides both Dealers and Investors with an environment in which such trades may be conducted in a manner to ensure financial compliance with regulatory requirements.

Advantageously, the methodology described herein enables a Dealer to readily access market information which under normal circumstances would potentially not be available without prior knowledge of the market and/or traders. Furthermore, the described methodology also allows for the systematic generation of reports and/or audits, which ensure that the trades are conducted in accordance with the regulatory requirements.

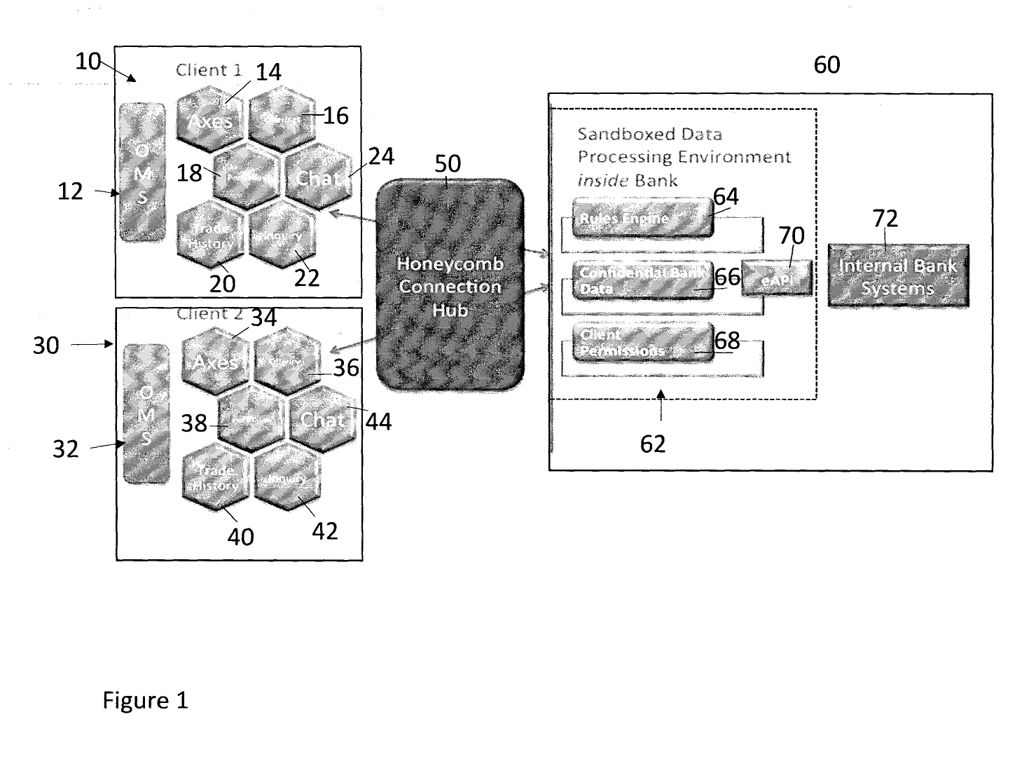

FIG. 1 is a schematic of the apparatus according to an aspect of the invention.

There is shown a first buyer's system 10, comprising an order management system (“OMS”) 12, with modules storing data relating to axes 14, offerings 16, portfolios 18, trade history 20, inquiries 22 as well as a communication module 24. There is also shown a second buyer's system 30, comprising an OMS 32, with modules storing data relating to axes 34, offerings 36, portfolios 38, trade history 40, inquiries 42 as well as a communication module 44.

The first buyer's system 10 and the second buyer's system 30 are in communication with a third party connection hub 50. The third party connection hub 50 is in communication with a first seller's system 60. The first buyer's system 10, the second buyer's system 30 and the first seller's system 60 are not in direct communication with each other and all communication between the individual systems (10, 30, 60) are directed through the third party connection hub 50.

The communication modules 24, 44 are preferably a secure communication line which is encrypted using known communication protocols. The communication module 24 in an embodiment allows for one or more forms of communication such as VOIP, video messaging, instant messaging etc.

As described in further detail below, the communication modules 24, 44 receive parsed data from the individual systems. They also push information, from the OMS system 32, to communication hub 50. The information from the buyside OMS system is parsed through the Central Communications Hub (system 50) in order to provide dealers (sell side) with portfolios information. The flow of information between the OMS system 32 is therefore bi-directional.

The first seller's system 60 comprises a sandboxed data processing environment 62 having a rules engine 64, a database containing confidential bank (or seller) data 66 and a module detailing the sandboxed data processing environment's permissions 68. The rules engine, 64 and client permissions 68, are preferably administered via a web service administrative tool, which is accessible from a secure connection by approved users of that system, 60. The web service administrative tool allows system 60 the ability to define the specific content and permissions settings that system 60 shares with buyers' systems 10 30. The type of content and permissions are described in detail in subsequent sections in this document. As the process is sandboxed within the seller's computer system access to data sources and communications channels is strictly limited, thereby ensuring that the seller's internal systems 72 cannot be freely accessed by the sandboxed data processing environment 62. Communication between the sandboxed data processing environment 62 and the seller's systems 72, as well as between the seller 60 and the third party communication hub 50 is controlled via an eAPi 70. The eAPi 70 functions in a known manner to control communication.

As described in detail below, communication between the various parties is controlled via the Central Communication Hub 50 (or Central Communication Hub), thus controlling the flow of information.

In FIG. 1 two buyers 10 and 30 and a single seller 60 are shown for clarity. In practice there are many more buyer and seller systems which communicate through the Central Communication Hub 50.

In the example shown the Investor (the buyer) is the party which initiates the request and the Dealer (the seller) the party which responds to the request. In further examples of the invention the role of the seller and buyer are transposed i.e. the seller, who is looking to sell a particular product, will initiate the request and the buyer (dealer) will respond.

To ensure the secure transmission of data the eAPi 70 data is typically sent using a VPN or using a trusted source such as BT Radianz.

The architecture comprises a number of modules described below:

| Component Name | Responsibilities |
|---|---|
| User Data Module | Responsible for loading/persisting user state into the in- |
| | memory data grid (IMDG) from the database; this includes |
| | role, sales coverage and client information as well. |
| Instrument Data Module | Loads instrument static into the In Memory Data Grid |
| | (IMDG) from various sources (including Web Services). It |
| | can also be configured to detect static file dump changes |
| | and apply these to the database. |
| Instrument View Module | Loads instrument static into the TSA from various sources |
| | (including Web Services). It can also be configured to |
| | detect static file dump changes and apply these to the |
| | database. |
| eAPI JMS Gateway Module | Acts as a bridge between the internal and external Java |
| | messaging service (JMS) buses. This is the primary |
| | mechanism for E-integration between external systems and |
| | Synchronicity. |
| Tactical Monitor Module | Includes a log monitor that scans all configured log files to |
| (Optional) | look for specified alert strings, in addition to a process |
| | monitor that periodically checks that all configured |
| | processes are still running. |
| Order Module | Loads and persists all orders entered in the platform into |
| | the IMDG and database. Also responsible for managing the |
| | lifecycle of an order. |
| CLOB Module | Aggregates liquidity across a number of markets (both |
| | internal and external where available) into a centralized |
| | limit order book (CLOB). |
| Crossing Module | Uses order state in the IMDG to build and manage real- |
| | time crossing opportunities across all live orders. |
| Negotiation Module | Manages the lifecycle of a negotiation/request for |
| | quotation (RFQ) while ensuring the associated state is |
| | loaded and persisted into the IMDG and database. |
| Trade Module | Manages the trade lifecycle and loads/persist state across |
| | both the IMDG and database. |
| View Modules | Normalizes order, negotiation/RFQ, trade and CLOB state |
| | within the IMDG into various views for consumption by |
| | other modules and web application UIs. |
| SSO | Depended on by all other web applications to manage user |
| | authentication and authorization by exposing centralized |
| | single-sign-on services and login interfaces. This can also |
| | be configured to integrate with a SAML2 compliant |
| | Identity Provider. |
| Synchronicity Server | A thin server layer that manages the bridge between the |
| | modules and Flex clients via the JMS bus. |
| User Service | An API to add/modify client user and role data and query |
| | these details. |
| SMS Service | An API that allows for SMS notifications that can be |
| | replaced by a dealer implementation. |
| Order Entry Service | An API for submitting order(s) electronically that includes |
| | trader axes/offerings. It also allows for submitting and |
| | maintenance of client portfolio holdings. |
| Trade History Service | An API for submitting historic trade data. |
| Trade Service | An API for acknowledging STP has been successful via |
| | dealer systems. |
| Dealer Trade Service (Bridge) | An API for processing executed trades by notifying the |
| | dealer via email. This service is intended to be a dealer |
| | implementation of which Synchronicity is a client but in |
| | the absence of one, this tactical instance is used. |
| Synchronicity Integration | This Module manages the system integration with all |
| Module | dealer endpoints and implements the E-API |
| Desktop Air Application | The GUI used by Sales and Traders to perform |
| | Honeycomb functions |

In further embodiments (not shown) third party sources are used to provide information to investors. In these embodiments the third party data is incorporated into the system through a data reseller model. The client systems 10, 30 are associated with one or more third party data sources (for example through a subscription) and access to information to each of these data sources is managed via the connection hub 50. In such embodiments different data packages (and/or third party data sources) are available for clients to choose from. The data packages differ in terms of data provider sources, data points and frequency of information updates (intraday, continuous, etc). Dependent on the provider of the data, the data points and their evaluations or offerings can vary.

In certain embodiments the data points provided for include one or more of:
Bid/Offer cash price
Bid/Offer Benchmark-Spread price
Bid/Offer Z-Spread price
Bid/Offer Yield To Worst
Bid/Offer CDS
Liquidity Score
Trace data
Euroclear data
Market Sentiment data
Research
Trade Ideas
Repo/Financing Data
New Issuance
Each participants response rating/score in relation to instrument as voted for by the Buyside in previous transactions

The information is displayed on each client system on an individual inquiry basis. This means that the evaluations and information provided are unique to each inquiry, and multiple data sources for the different data points are tailored to the end user for each specific inquiry based on their contracted data package. The data is primarily provided through a FIX connectivity feed, however alternative connectivity options may also be used.

Preferably in order to ensure the accuracy of the third party sources accessed in such embodiments, the third party data sources are validated. The validation of the sources in an embodiment is from the operator of the system, and in further embodiments validation is performed by a further party, such as a regulatory body. Validation of the data source involves certification by the independent operator of the network that data sources connected to the above system are valid sources for trade processing purposes and as such can be considered valid. Such validation of the data source occurs in an embodiment in a known manner where third party sources are deemed “trusted”.

Furthermore, the invention provides a secure web service system wherein the Dealer is capable of controlling the specific permissions and types of contents that are released from within the sandboxed data environment to other systems within the network during the pre-reveal phase. This system also embodies the way that Dealers can view client firms they can potentially connect to within the network (that they have not been excluded from). When the request for a connection to a client from a Dealer has been accepted, the firm is then connected and the contract between the parties is in place.

Administrative functions such as user and firm mappings are included in the web service system. These mappings are manageable by the overall system administrators on behalf of a dealer or client, or by the dealer or client themselves. Within the service individual users of the web service system are assigned a specific type of user role. Each user role has different parameters. These roles vary from sales and trader users, to approvers and compliance related roles. Some roles require appropriate approvals from other users in order to take full effect in order to meet compliance requirements. Therefore, the web service enables full control over the dissemination of information from within the invention.

Auditing is an aspect of the web service system as well. Any action taken by a web service system user is audited for regulatory and compliance purposes. Each action is logged and all logs can be recalled by specific user types.

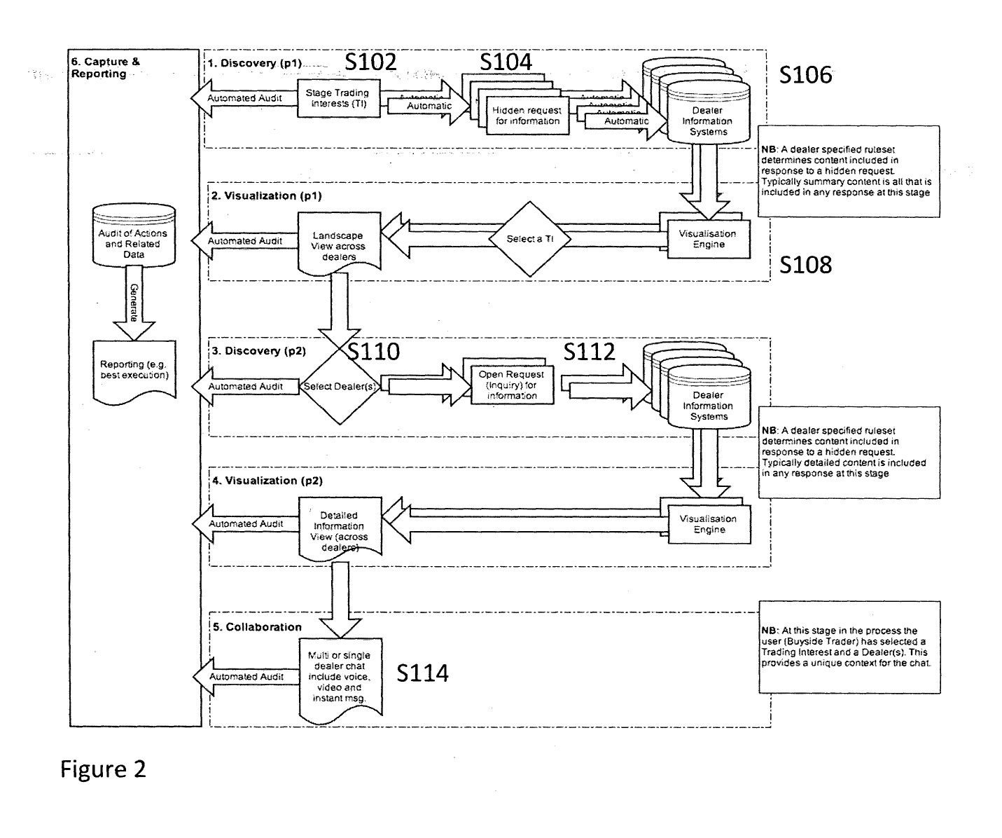

As described with particular reference to FIG. 2 below these features interact to provide a secure system for conducting OTC trades.

FIG. 2 is a flow chart of the process of conducting over the counter trades according to an aspect of the invention.

The following is described with reference to a single buyer (Investor) and a plurality of sellers (Dealers) for ease of reference. The number of individual dealers and investors in practice are much greater though the concepts described herein are the same. The trades are conducted via a Central Communication Hub.

As described in detail with reference to FIG. 1, multiple Investors are able to log on to a Central Communication Hub 50, or service, via a terminal at the Investor's system 10, 20. The Central Communication Hub 50 in an embodiment is held in the cloud, enabling remote Dealers and Investors to log-in and access the invention. The terminal may have a thin client or the like to enable the Dealer to contact the Central Communication Hub. All communication between the Dealers 60 and Investors 10 30 is regulated via the Central Communication Hub 50 to help maintain the initial anonymity of the parties, and to facilitate contact between multiple buyers and sellers.

At step S102 an Investor inputs a trading interest. The trading interest is representative of an investor's investment decision, for example, the decision to buy or sell a certain amount of a given security.

In the majority of traded bonds, the market is fragmented and the interest in a particular bond may be small with trades occurring on an irregular (less than once a day) basis. Accordingly, an Investor's knowledge of a particular trading interest at this stage may be limited, and/or out of date. In order to obtain the optimal deal for the trading interest it is therefore necessary to be able to obtain as much preliminary information as possible at the initial stage so as to enable the investor to make a decision with regards to the trade of the bond. Furthermore, in order to maintain anonymity and therefore prevent market spoiling, the flow of information must be controlled so as to avoid unnecessary leakage of information.

To control the flow of information the trading interest is therefore anonymised and hidden requests for information are generated.

At step S102, in order to complete any regulatory requirements regarding auditing and in order to prove that the trader is acting on the best interest of their client, once the trading interest has been inputted into the terminal, an audit document is created stored in the Central Communication Hub. Preferably the audit document is assigned a unique ID.

Therefore, at step S104, the trading interest inputted at step S102 is analysed by the Central Communication Hub (at step S104) in order to generate a hidden request for information (at step S104).

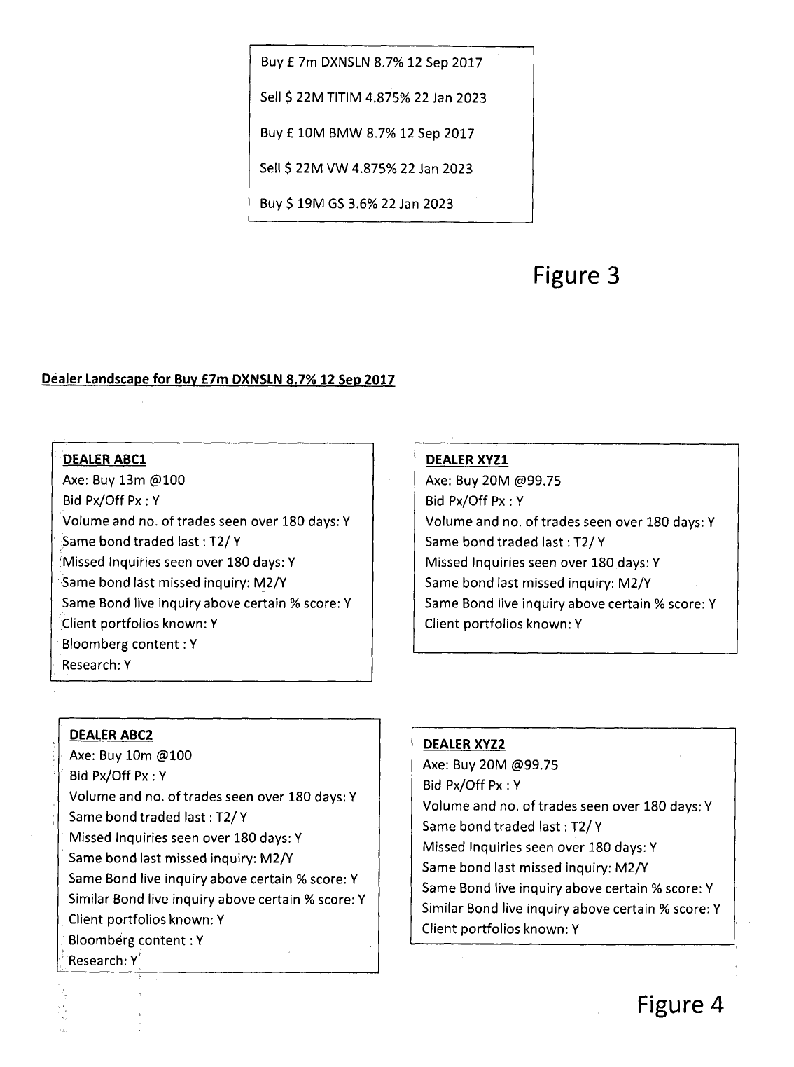

As described in greater detail with reference to FIG. 3, the request for information is said to be hidden due to the fact that the response to the request for the information is generated automatically by the computer systems of a given Dealer, and the individuals working at a particular Dealer would not know that a request for information has been received and a response generated.

At step S104 any data in the trading interest which identifies the buyer who has entered the request is removed by the Central Communication Hub. The Central Communication Hub also initiates the hidden request for information to the Dealers therefore maintaining the anonymity of the Investor.

The hidden request for information generated at step S104 is sent to the computer systems of multiple Dealers, by the Central Communication Hub, at step S106 with a view of determining the ability for a particular Dealer to fulfil the trading interest.

At step S106 the trading interest reconciliation engine (as described in detail with reference to FIG. 3) queries multiple Dealers in order to determine their initial appetite in the anonymised trading interest request. The computer system of each Dealer generates a hidden response which is forwarded to the Central Communication Hub and collated and subsequently forwarded onto the seller.

At step S106, the hidden request for information has been received by the Dealers. If the Dealer has information that is defined relevant to that particular inquiry by the parameters set (by the Dealer), information will be sent back through the Central Communication Hub to the Investor that has initiated the trading interest (inquiry). In a preferred embodiment the Dealers that receive the inquiry are the Dealers that are connected to the inquiring Investor. In such embodiments the inquiry is not sent to every Dealer in the network, only the Dealers that have contracted connections with that specific individual Investor. In further embodiments information is provided by Dealers that are not directly connected with the Investor, and in such embodiments this information is in the form of email messages that a third party vendor parses on behalf of the Investor; consequently in such embodiments this service is not “real time”.

Preferably, the specific content that gets sent back during the hidden and subsequent revealed phases is customized via an administrative tool. The content that the Dealers wish to publish to specific firms is managed by an approver list of people at the Dealer firm.

As the flow of information is controlled by the Central Communication Hub, the possibility of information leakage is reduced. Furthermore, due to the hidden nature of the request, the traders acting on behalf of the seller are unaware of the receipt of the hidden request for information. (Described in further detail with reference to FIG. 2).

At step S106, the hidden request has been generated and the Dealer's systems have been queried with the hidden request for information, the responses are inputted into the audit document as generated at step S102. Therefore, a comprehensive audit trail of the trading interest and initial response is automatically generated, removing the burden from the parties involved. The audit document is stored at the Central Communication Hub and may subsequently be submitted to an appropriate regulator in accordance with any compliance practices.

The amount of information given by the individual Dealer in response to the hidden request for information at step S106 is determined by the Dealer's system preference. Typically when conducting OTC trades the amount of information initially presented in response to a request for information is limited to what is known as pre-trade information. Such information is typically limited to the axe, historical volume of trading or missed trade in the particular bond, the price value of the bond, etc.

At step S108, the information as collated by the Central Communication Hub at step S106, is visualised at the Investor's terminal. The visualisation (presented via the graphical user interface or “GUI”) allows the Execution User to view all the responses received by the multiple Dealers in order to determine each Dealer's risk appetite on the bond. In particular it allows the Investor to receive a range of information to assess which is the best Dealer to speak to for the specific inquiry (if anyone).

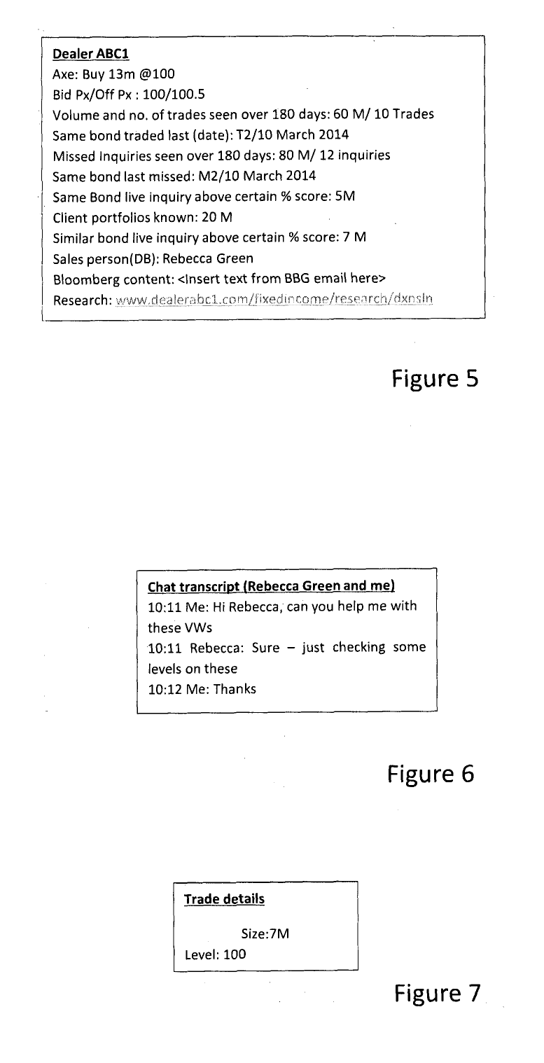

An example of the visualisation of the data is presented in FIG. 5.

At step S110 the Investor is enabled to select one or more of the Dealers in the Dealer landscape as presented in step S108. The selection of the one or more dealers may occur by known user input means, for example selection with their mouse, touch screen interface, etc.

The Execution User's selection of a particular Dealer may be based on the information presented in the visualized GUI dealer landscape market as well as the trader's knowledge of the Dealers and/or the market.

Optionally when the Execution User has made a selection of one or more dealers the selection is automatically recorded in the audit document created for the trading interest.

At step S112 in response to the selection of the one or more Dealers a request for further information is generated. At this time, the pre-reveal stage is now transitioning to the reveal stage. During the reveal stage, the Dealer is informed who the inquiry is from, whilst revealing more detailed information regarding the bond inquiry.

The transition to the reveal phase is initiated by the Investor's Execution User and leads to a request for further and more detailed information from the Dealer in exchange for revealing the interest in buying or selling a bond. The request for further information requested at step S112 is sent from the investor terminal to the Central Communication Hub and subsequently forwarded on to the appropriate Dealer's system.

In response to the request for further information the dealer responds with the information requested and such information is visualized on the Investor's GUI display. As with steps S102 and S106, the request for further information and subsequent response are automatically inserted into the audit log.

As well as visualizing the response to the request for further information, the Investor's terminal is also presented with an option to open a secured communication channel directly to a user at the Dealer. Therefore, the system hosts the communication (for example, instant messaging, voice or video etc.) so that the trade may be completed. Advantageously, at this stage some or all of the communication between the Investor and Dealer using the secured communication channel is also recorded in the audit log for regulatory purposes.

The secured communication channel may be protected using known encrypted instant messaging technologies or the like. Once the trade has been agreed upon and executed (which is done outside of the system via each party's respective back office clearing systems), the Execution User can input them in the system that will record them into the auditing log which is subsequently closed and time stamped with a unique identifier.

FIG. 2 has been described, for the purpose of clarity of description, with reference to a Investor's Execution User looking to buy a particular bond. The same concepts may be used in order to offer to sell, and subsequently sell a bond. The processes described are the same, with the same exchange of information between the two parties via the Central Communication Hub.

The ability to obtain the information in response to the request for information in a hidden manner helps ensure that the problems associated with the information leakage and spoiling are avoided.

In order to query the Dealers' systems in a secure and confidential manner, a sandboxed data processing environment is installed in each of the Dealers' banking systems, enabling the Central Communication Hub to query the host Dealer's system in response to the trading interest received from the Investor. By having a sandboxed system on each Dealers' computer systems, the Central Communication Hub's access to sensitive data is restricted (thereby ensuring the host Dealer that their systems are not compromised) and further prevents the host Dealer from accessing the environment, thus ensuring the control of information.

The sandboxed data processing environment therefore interacts with the data repositories and services of the host seller's computer system in order to ascertain the relevant information. The Central Communication Hub, via a VPN or other form of secured connection, is able to communicate directly with the sandboxed data processing environment installed on each system. Therefore, in use, communication between the buying and selling parties is regulated via the Central Communication Hub. The regulation of the communication between the parties via the communication hub occurs in a known manner.

As the process is sandboxed within the Dealers' systems, access to data sources and communications channels is strictly limited. The amount of data that can be accessed by the sandboxed data processing environment as part of the pre-trade information, as per step S106, can be controlled by the Dealer, depending on the preference of the Dealer. Typically data relating to:
trade history;
missed voice inquiry (if centrally stored & available);
missed e-RFQ inquiry;
portfolio holdings data;
live offerings data;
axe feeds;
guaranteed firm price feed (if available);
liquidity from a dealer's single dealer solution;
research;
desk analyst commentary;
new issuance activity,
   is stored or obtained from 3^{rd} parties providers and delivered to the sandboxed data processing environment.

Such information is provided as a subscription service, which is automatically updated at the sandboxed data processing environment when the data changes. For example, if the axe for a particular product changes, then the updated axe is forwarded to the sandboxed data processing environment. In an example of the invention the information is stored within a database contained within the sandboxed data processing environment.

When a hidden request for information is received at the sandboxed data processing environment of a given Dealer's computer system (as per step S106) the information stored in the sandboxed data processing environment is queried to identify matches to the request. As the data is provided to, and stored in, the sandboxed data processing environment the hidden request for information from a given Investor is fully contained within the sandboxed data processing environment. Accordingly, other users of the Dealer's computer system (such as other traders) will be unaware of the request for information, and the system's response.

Given the low volume of trades in many bonds and the difference in products that may be available, products identical to those indicated in the trading interest (as per step S102) may not be available. Accordingly, in a preferred embodiment the hidden request for information at step S106 may identify similar products which are identified according to a determined likelihood of a match between the trading interest and the identified product. The identification of similar products occurs using the methods described in U.S. Ser. No. 13/879,801, in the name of Algomi Limited, the contents of which are incorporated by reference.

The sandboxed data processing environment typically contains the following modules to process and return the hidden data requests.

FIGS. 3 to 8 show sample screen shots of the information which would typically be displayed at a buyer's terminal as a result of the process as described with reference to FIG. 1.

FIG. 3 shows a typical trading interest which is entered into the system by the investment management trader (IMT). In the example shown in FIG. 3 the IMT has entered five separate trading interests relating to a variety of buying and selling interests in a number of bonds. Such trading interests are inputted into the system as described above with reference to step S102.

The trading interest as shown in FIG. 3 are then used to generate a hidden request for information (as described with reference to step S104). In a preferred embodiment each trading interest generates a separate hidden request for information.

FIG. 4 shows a typical screen shot for the visualised market (as per step S108) which has been generated in response to a request for hidden information (as per steps S104 and S106) which originates from the trading interest shown in FIG. 3. In the example shown in FIG. 4, the trading interest in this example is the first trading interest inputted as shown in FIG. 3, i.e. buy 7 million DXNSLN. In the example shown in FIG. 4, the landscape generated (as per step S108) shows the results from four separate dealers (ABC1, XYZ1, ABC2 and XYZ2). Typically the number of dealers shown in a landscape would be much larger, and four are shown for the purpose of clarity.

As can be seen in FIG. 4, the information provided relates to the axe, as well as historical information regarding the number of trades performed over a set period of time. In the example shown the information provided relates to the volume and number of trades over the previous 60 days, however this timescale may be adjusted to the user preference. Further information regarding the dealers, for example knowledge of the client portfolio, third party content, research etc. may also be presented at this stage. As can be seen in FIG. 4 therefore the IMT is presented a selection of pre-trade information for the inputted trading interest (i.e. as per step S102) which under normal circumstances given the low volume of trade for the inputted bond, would typically be unknown to a buyside Investor firm.

As per step S110 the IMT may select one of the four options presented in order to request further information to ascertain whether the IMT wishes to initiate a trade with the selected dealer. The choice of selection of the dealer would typically be based on the IMT's experience of the dealer, knowledge of the market etc.

The response to the request for further information is visualised at the display of the IMT as shown in FIG. 5. In the example shown in FIG. 5, the IMT has selected a dealer ABC1 and has obtained further information with regards to the dealer. For example the volume and number of trades over the last sixty days now lists the extent of the volume and number (in the example shown in FIG. 5, 60 million in volume over 10 trades). Similarly, the request for further information shows that the last trade of the same bond occurred on the 10 Mar. 2014 thereby giving the IMT an insight to the amount of trade a particular dealer may have with the trading interests.

As can also be seen in FIG. 5 the request for further information lists a relevant contact person, in this particular instance a Rebecca Green. The interface also provides the IMT with the ability to open a secure communication channel in order to contact the listed sales person.

In FIG. 6 there is shown an example of a secure communication channel which has been opened by the IMT in order to contact the dealer so as to complete the trade.

In the example shown in FIG. 6 the secure communication channel is an instant messaging channel and as described above with reference to FIG. 2 the transcript of the instant messaging channel is automatically audited.

In FIG. 7 the trade has been agreed upon and in the example shown in FIG. 7 a trade size of 7 million and a level of 100 has been agreed upon.

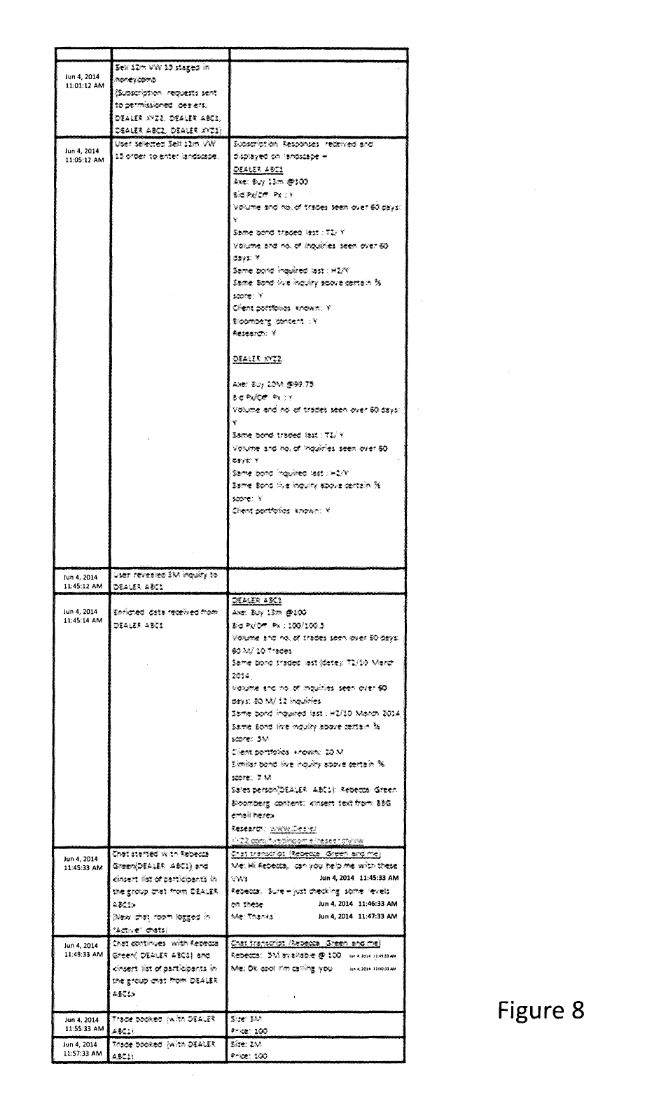

In FIG. 8 an example of an automatically generated audit report is provided showing the history of the process from the input of the trading interest (as per FIG. 3) to the completion of the trade (as per FIG. 7) which also provides relevant information regarding the dealer landscape. Such information therefore allows the IMT to demonstrate that they have obtained the best possible price for their client as required by regulatory requirements.

Therefore the present invention provides both the buyers (Investors) and sellers (Dealers) to be able to access information regarding a market which would otherwise be unknown to the party. As stated above, the majority of bonds are traded on an infrequent basis and information regarding a particular product may be limited or unknown to a party. By having the parties communicate via a trusted third party via the connection hub hidden information may be readily accessed. Further as the information is obtained from a sandboxed data processing environment the second party in question (e.g. the Dealer as the seller) would be unaware that such information has been requested, and therefore would remain unaware of the first party's (e.g. the Investor as the buyer) interest. As communication between the parties is handled via the Central Communication Hub and information regarding the trading interest is initially hidden, information leakage is minimised.

1. A system for conducting over the counter trades, the system comprising:
a first initiating party's computer system;
a second responding party's computer system; and
a Central Communication Hub in contact with the first and second parties' computer systems; wherein
the first system is configured to enable a user to input a trading interest in a financial instrument, and to send information indicative of the trading interest to the Central Communication Hub;
r infoCentral Communication Hub is configured, in response to the receipt of the information the information indicative of the trading interest, to make a hidden request for information to the second system, or range of systems throughout the network,
the second system is configured to respond to the Central Communication Hub's hidden request for information with summary information, pertaining to the trading interest from the first system; and
the Central Communication Hub is further configured to forward some or all of the summary information response to the first party's system.

2. The system of claim 1 wherein the system further comprises a plurality of responding parties and each responding party's system receives the hidden request for information from the Central Communication Hub and is configured to generate summary information in response to the request.

3. The system of claim 2 wherein the first initiating party's system is further configured to display the summary information from the plurality of responding parties and to enable the buyer to select a responding party from the presented summary information.

4. The system of claim 3 wherein the first initiating party's system is further configured to providing a communication channel at the Central Communication Hub for the buyer and the first seller to communicate, via the Central Communication Hub, to enable completion of the trade of the financial instrument, in response to the selection of a responding party, wherein the form of communication is one of chat, VOIP, video.

5. The system of claim 1 wherein the response to the hidden request is generated in a sandboxed data processing environment.

6. The system of claim 5 wherein the sandboxed data processing environment is installed on the responding party's computer system.

7. The system of claim 6 wherein the sandboxed data processing environment communicates with the responding party's computer system via a VPN.

8. The system of claim 1 wherein communication to and from the Central Communication Hub for each inputted trading interest is recorded in an audit log.

9. The system of claim 1 wherein the first requester's system is further configured to generate a second, open, request for further information, which is sent to the Central Communication Hub.

10. The system of claim 1 wherein the response to the hidden request for information is automatically generated by the seller's system without human intervention.

11. A method of conducting over the counter (“OTC”) trades, between a first initiating party, a second responding party and a trusted third party, the method comprising:
the first party inputting a trading interest in a financial instrument, and sending information indicative of the trading interest to the Central Communication Hub;
the Central Communication Hub, in response to the receipt of the information indicative of the trading interest, making a hidden request for information to the second system, the hidden request for information indicative of the second party's ability to fulfil the trading interest;
the second system is responding to Central Communication Hub to the hidden request for information with summary information indicative of the second system indicative of the second party's ability to fulfil the trading interest; and
the Central Communication Hub forwarding some or all of the summary information response to the first party's system.

12. The method of claim 11 wherein the Central Communication Hub sends the hidden request for information to a plurality of responding parties, each responding party responding to hidden request.

13. The method of claim 12 comprising the step of displaying at first initiating party's system the summary information from the plurality of responding parties and selecting at the first party's system responding party from the presented summary information.

14. The method of claim 13 comprising the step of providing a communication channel at the Central Communication Hub for the buyer and the first seller to communicate, via the Central Communication Hub, to enable completion of the trade of the financial instrument, in response to the selection of a responding party.

15. The method of claim 11 wherein communication to and from the Central Communication Hub for each inputted trading interest is recorded in an audit log.

16. A Central Communication Hub for conducting over the counter trades between a first initiating party and one or more responding parties, the Central Communication Hub configured to:
receive a trading interest in a financial instrument from the first initiating party;
make a hidden request for information to one or more second responding parties, the hidden request for information indicative of the second party's ability to fulfil the trading interest;
receive summary information indicative of the second system indicative of the second party's ability to fulfil the trading interest; and
forward some or all of the summary information response to the first party's system.

17. The Central Communication Hub of claim 16 further configured to provide a communication channel between the first initiating party and a first responding party.

18. The Central Communication Hub of claim 17 configured to generate and store an audit log of communications to and from the hub for each received trading interest.

19. The system of claim 1, wherein the system is further configured to assign permissions to one or more users of the system, wherein said permissions define a user's access to information and/or the ability to communicate with a further party's system.

20. The system of claim 1, further comprising one or more third party data sources, wherein the communication hub is configured to access data from said third party data sources, preferably wherein the third party data sources are validated
